(19) United States
(12) Patent Application Publication
(10) Pub. No.: US 2016/0052192 A1
(43) Pub. Date: Feb. 25, 2016

(54) METHOD FOR REGULATING THE THICKNESS PROFILE OF INLINE-ORIENTED FILMS

(71) Applicant: Windmoeller & Hoelscher KG, Lengerich (DE)

(72) Inventors: Martin BACKMANN, Lengerich (DE); Markus BUSSMANN, Essen (DE); Jens GOLDENSTEIN, Osnabrueck (DE)

(21) Appl. No.: 14/930,455

(22) Filed: Nov. 2, 2015

Related U.S. Application Data
(63) Continuation-in-part of application No. PCT/EP2014/000618, filed on Mar. 10, 2014.

(30) Foreign Application Priority Data
May 2, 2013 (DE) 10 2013 007 669.2

(51) Int. Cl. B29C 55/06

(52) U.S. Cl. CPC B29C 55/06; B29K 2995/0097; B29K 2105/256

(57) ABSTRACT

The present disclosure relates to a method of regulating the thickness profile of inline stretched films which are manufactured in a blowing process. The films are positioned flat in a reversing take-off, which are laid and which are subsequently stretched monoaxially in a machine direction in a stretching unit. In accordance with the present disclosure, the thickness profile of the film is regulated such that a film produced by the stretching, having a deliberate thickening in its marginal region over the total film width, is of uniform thickness.

### CROSS REFERENCE TO RELATED APPLICATIONS

The present application is a continuation-in-part of PCT International Application PCT/EP2014/000618, entitled “Method for Regulating the Thickness Profile of Inline-Oriented Films,” filed on Mar. 10, 2014, which claims priority to German Patent Application No. 10 2013 007 669.2, filed May 2, 2013, the entire contents of each of which are hereby incorporated by reference in their entirety for all purposes.

### TECHNICAL FIELD

The present disclosure relates to a method of regulating the thickness profile of inline stretched films, preferably tubular films which are produced in a blowing process.

### BACKGROUND AND SUMMARY

Blown film extrusion units, which have already been in use for a long time, are usually used for manufacturing tubular films in the blowing process. Plastics are supplied to such units in pellet form and are then plasticized in extruders to form a viscous mass at a high pressure application. This mass, which has a high temperature due to the pressure, is formed into a ring shape in a blower head and escapes from the blower head through a ring nozzle. The mass already forms a film tube directly after leaving the ring nozzle. This film tube can, however, be varied in diameter since it has not yet completely cooled down. As a rule, the diameter is increased when compressed air is blown into the inner space of the film tube. The film tube is guided at a spacing from or directly along film guiding elements so that it always has a constant diameter. This arrangement of the film guiding elements is known as a calibration cage in the field of blown film extrusion units.

After running through the calibration cage, the film tube can be positioned flat in a reversing take-off, laid and subsequently stretched monoaxially in the machine direction in a stretching unit.

The properties of thermoplastic films can be changed in a targeted manner by the stretching thereof. Such properties are, for example, the transparency or the strength. Such as stretching, which can take place in a transverse direction and/or longitudinal direction of the film web, can take place inline directly after the extrusion process. The stretching or extending of thermoplastic films is described, for example, in WO2006/063641 A1 and in WO2011/057918 A1.

In the manufacture of tubular films, film thickness profile regulation systems having segmented regulating zones are used. The film thickness profile can be regulated by these systems such that the thickness differences over the total tube periphery are as small as possible.

A method is already known from DE 3941185 A1 for regulating the film thickness of tubular films from film blowing units having a downstream axial or bi-axial stretching of the blown-up tubular films in a furnace so that a final film is produced which has thickness differences which are as small as possible.

On longitudinal stretching in a stretching unit, the film is stretched in accordance with the degree of stretching in the machine direction and the film thickness is thereby reduced. At the same time, the film constricts in the transverse direction, whereby the width of the film reduces. This constriction has the result that the stretched film increasingly becomes slightly thicker from the film center in the direction of the film margins although it was previously regulated to a thickness which is as constant as possible in the blowing process. This thickness increase is particularly pronounced in the marginal film regions. This causes an edge build-up at the film wrap on subsequent winding up of the film. The film web is stretched more and more at the margins as the wrap diameter increases.

To manufacture films having a thickness profile which is as uniform as possible, such as is in particular required for printing or laminating, the film margins which do not correspond to the desired thickness profile have to be cut off. However, a large part of the film width is lost by this cutting off which is also called trimming. Up to approximately 200 mm is thus lost on each side of the film by the trimming, i.e., the cutting off.

A method of the category has become known from EP 2 277 681 A1 in which the film thickness profile of the tubular film manufactured in the film blowing unit is regulated such that a film having a thickness profile with differences from the mean film thickness which are as small as possible over the total film width is manufactured by the stretching. For this purpose, a tubular film is manufactured in the film blowing process which has two oppositely disposed thin points. When the tubular film is laid flat, care is now taken that the thin points form marginal film regions and that the stretched film then has a thickness profile with differences from the mean film thickness which are as small as possible. The deliberately introduced thin points therefore compensate the thickened portions in the marginal region which arise later on the stretching so that a uniform film thickness should result which extends up to and into the marginal region.

However, there is a problem with the films with the thinner marginal regions that the thin points have less roll contact when passing through the rolls of the stretching unit, which is disadvantageous in the manufacturing process, and in particular in the stretching process, since the grip may not be sufficient in the marginal region.

It is therefore the object of the present disclosure to further develop a method of the category such that this can be carried out with as little disturbance as possible to manufacture a film with a uniform thickness profile with which there is as small a loss as possible when cutting away the margin.

This object is achieved in accordance with the present disclosure by a method regulating a thickness profile of an inline stretched film comprising: positioning the film flat in a reversing take-off; and after laying the film in a stretching unit, stretching the film monoaxially in a machine direction, wherein the stretching includes regulating the thickness profile of the film to have a deliberate thickening in a marginal region with respect to a mean film thickness over a total film width without marginal regions.

This means that, unlike the prior art in accordance with EP 2 277 681 A1, thick marginal regions are deliberately formed which are additionally thickened during the stretching in the stretching unit. A substantially better grip, that is an improved contact between the film margins and the rollers of the stretching unit, is therefore made possible by this thickening in the marginal region. This results in a disturbance-free manufacture of films which have a very uniform film thickness, with the exception of the marginal regions.

Accordingly, the film thickness in the marginal region is advantageously formed between 15% and 100% thicker than the mean film thickness which results without these marginal regions.

The marginal regions which are formed thicker are narrow with respect to the total width of the film, for example in the range of 5 mm to 20 mm, or in the range of 7 mm to 10 mm. It is hereby therefore achieved that substantially fewer offcuts are generated in the manufacture of the film.

In accordance with an advantageous embodiment of the present disclosure, two thick points are formed next to one another in the marginal region of the film between which a thin point is arranged. In this respect, the thick points are comparatively close to one another. The film has less roller contact at the thin point due to the temperature regulation of the film with rollers and thus remains colder than the film at the adjacent thick points. The film can hereby again receive more transverse forces on stretching, which produces a further improvement of the film handling during the manufacturing process.

The extruded tubular film is advantageously regulated to the predefined desired thickness profile over its periphery.

In the method in accordance with the present disclosure, the desired profile laying over the film width arising due to the reversing take-off is advantageously taken into account and continuously reregulated, with an association of one or more peripheral points of the flat-positioned tubular film with or more regulating zones being taken into account in the regulating algorithm for controlling the segmented regulating zone. These regulating zones are the correspondingly segmented zones in the film blowing head via which the thickness of the manufactured tubular film can be set.

The desired thickness profile is advantageously regulated via an algorithm from the values of a measuring device which measures the film thickness by the monoaxial stretching in the direction of the machine over the total film width.

The algorithm for controlling the individual segmented regulation zones comprises a superposition of the base profile from the film thickness profile regulation of the film blowing unit and of the stretch profile from the laying of the tubular film by the reversing take-off while further taking account of influences by the stretching process.

Finally, the thick marginal region which is formed very narrow in accordance with the present disclosure can be cut off in order to obtain a film having a uniform thickness profile over its width.

Further features, details and advantages of the present disclosure will be explained with reference to an embodiment shown in the figures.

### BRIEF DESCRIPTION OF THE FIGURES

FIG. 1 shows a blown film extrusion unit in accordance with the prior art.

FIG. 2 shows a flat-positioned tubular film in accordance with the prior art.

FIG. 3 shows a flat-positioned tubular film in accordance with the present disclosure.

FIG. 4 shows an example actual thickness profiles of a film tube prior to the stretching in the stretching mechanism.

FIG. 5 shows another example actual thickness profiles of a film tube prior to the stretching in the stretching mechanism.

FIG. 6 shows yet another example actual thickness profiles of a film tube prior to the stretching in the stretching mechanism.

FIG. 7 shows still another example actual thickness profiles of a film tube prior to the stretching in the stretching mechanism.

FIG. 8 shows an actual thickness profile of a film tube in accordance with the present disclosure after the stretching in the stretching mechanism.

FIG. 9 shows a flow chart illustrating a method that may be implemented for producing tubular films in a blown film extrusion unit.

### DETAILED DESCRIPTION

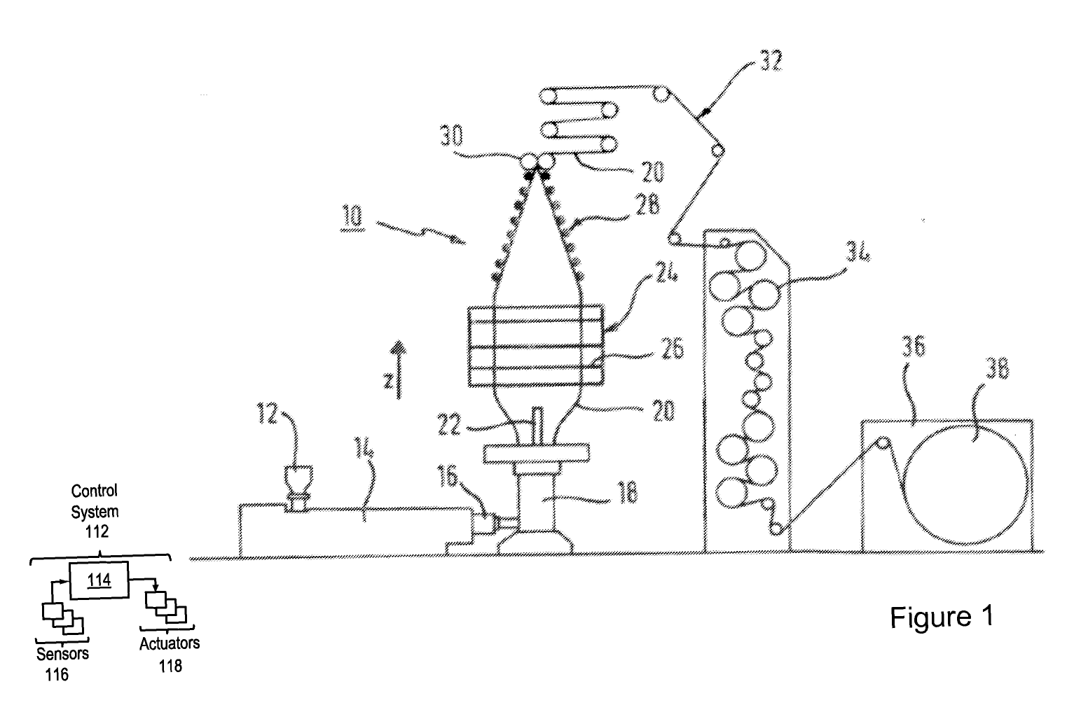

FIG. 1 shows example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example.

FIG. 1 shows a known blown film extrusion unit 10. A plastic is supplied through a pouring stub 12 and is then plasticized in an extruder 14. The mass which is produced is supplied via a connection line 16 to a blowing head 18 which forms a film tube 20. In this unit, the film tube 20 exits the blowing head 18 through a ring nozzle, not visible, in the direction of transport z.

Due to the supply of compressed air through a take-off stub 22, the film tube 20 is widened directly after exiting a blowing head 18. The diameter of the film tube 20 is, however, limited by a calibration cage 24. The film tube 20 is guided by plates within the calibration cage 24 by which compressed air is directed onto the film tube. The calibration cage 24 additionally comprises a frame 26. After exiting the calibration cage 24, the film tube 20 enters into a flat-positioning unit 28 in which the film tube is almost or completely reshaped to form a double-layer film web. In this unit, the film tube 20 is guided between pairs of guiding elements which adopt a continuously decreasing distance from one another in the course of the transport direction z. The complete flat-positioning takes place by a crimping apparatus which comprises a pair of crimping rollers 30.

The film web 20 is now guided by reversing apparatus 32 before it runs into a stretching mechanism 34. A corresponding stretching mechanism is described by way of example in WO2011/057918 A1 to which reference is made in full.

Finally, after exiting the stretching mechanism 34, the stretched film is supplied to a winding apparatus 36 where the film web 20 is processed to a wrap 38. Blown film extrusion unit 10 may further comprise a control system 112 having various switches and/or interfaces. The control system 112 may include a processor and memory 114, in combination with sensors 116 and actuators 118, to carry out the various controls described herein. For example, based on signals received from the control system, compressed air may be directed onto the film tube, and the film web may be moved from the calibration cage to the flat-positioning unit and then to the stretching mechanism. Sensors 116 may include temperature and pressure sensors coupled to the extruder cavity for estimating temperature and pressure of the molten thermoplastic material. In addition, a plurality of thickness measurement sensors may be coupled to different sections of the blown film extrusion plant to monitor the thickness of the film as it passes through stages such as stretching and winding. Actuators 118 may include motors used to spin screws attached to extruder cavity and rotate rolls in the stretching and winding mechanisms. Still other actuators may include valves and rotors coupled to the various components of the blow film extrusion unit. The motors may be electric motors, hydraulic motors, pneumatic motors, etc. In one example, based on a film thickness estimated by a thickness measurement sensor prior to the film entering the stretching mechanism, the speed of a motor may be regulated to vary the rotational speeds of the rolls in the stretching mechanism, in order to achieve a desired film thickness.

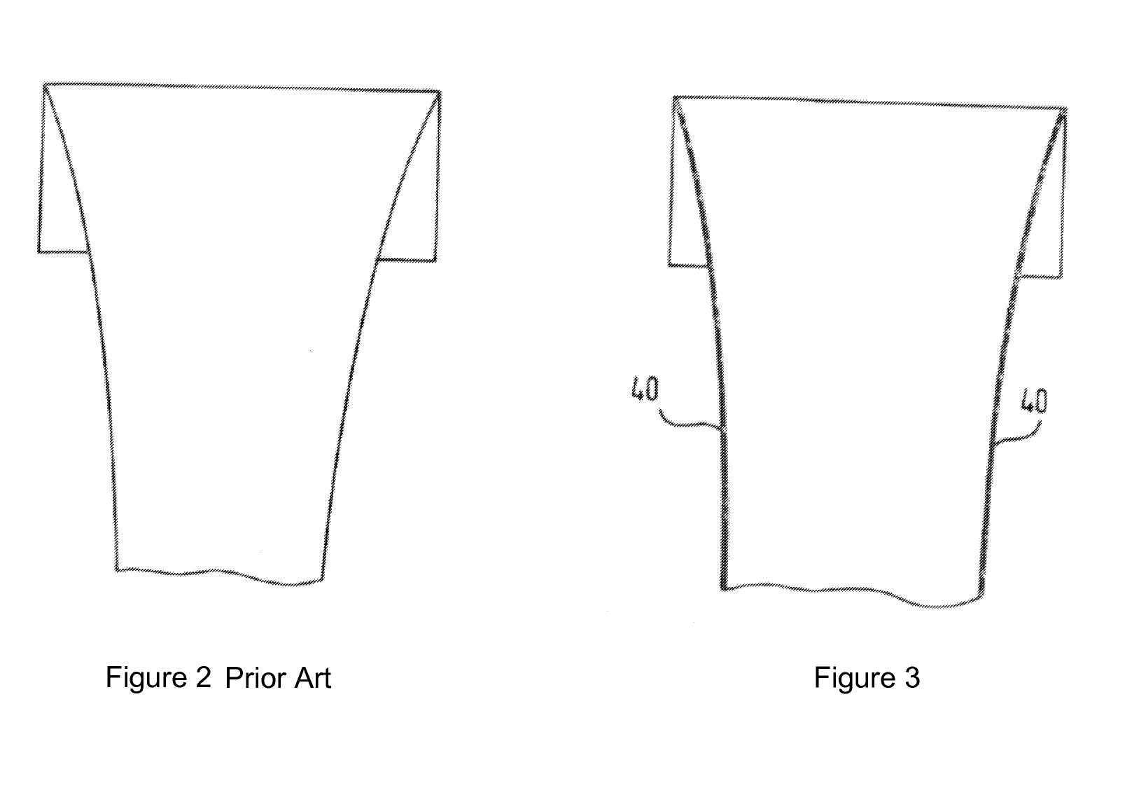

FIGS. 2 and 3 schematically show how the tubular film 20 is “constricted”, that is drawn in length, by the stretching in the stretching mechanism 34, while it loses width.

FIGS. 2 and 3 show a direct comparison between the prior art and the film manufactured using the method in accordance with the present disclosure. Said film has the thickened marginal regions 40. It should be made clear with reference to the two Figures that, with the same stretching conditions in the stretching mechanism 34, the film in accordance with the prior art tends to constrict much more than the film in accordance with the present disclosure, which is due to the reinforced narrow marginal regions 40.

Two thickness measurement devices which are not shown here for reasons of simplicity may be provided in the blown film extrusion plant 10 in accordance with FIG. 1. The first thickness measurement device is arranged in the region of the blown-up blown film before the laying together of the film tube. The second measurement device is arranged after the stretching mechanism and before the winding apparatus.

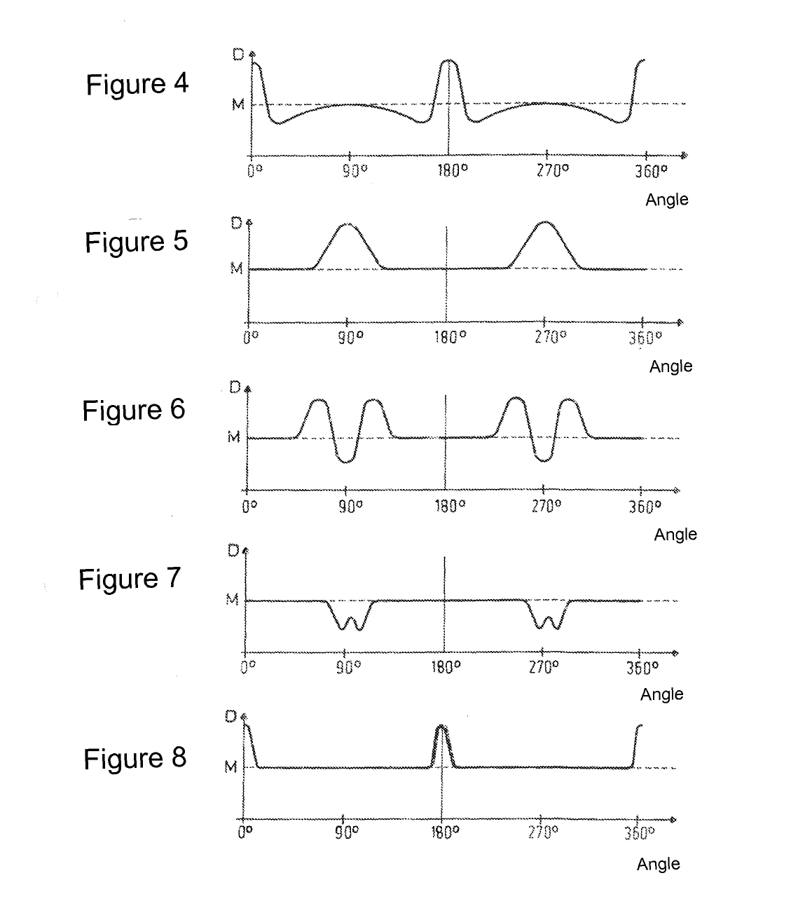

FIGS. 4 to 7 show thickness profiles in accordance with the present disclosure over the periphery of the film tube as measured by the first thickness measuring apparatus in the region of the film bubble. They represent thickness profiles before the stretching in the stretching unit 34.

It becomes clear from the thickness profile in accordance with FIG. 4 that here the marginal region is formed thickened in a narrow region at 0° or 360° and at 180°. The desired mean thickness profile of the film is shown by M. Slight thin points are provided in the region in front of the deliberately provided thickenings in the marginal region so that, after a corresponding stretching, the profile shown in FIG. 8 results as measured by the second measurement arrangement arranged after the stretching mechanism 34.

A thickness profile is shown in FIG. 5 which is phase-offset by 90° and in which a somewhat wider marginal region is configured as correspondingly thickened in comparison with the thickness profile in accordance with FIG. 4. Corresponding thinner points than the desired mean thickness profile are not provided here.

Two thickness points disposed closely next to one another and having a thin point arranged between them are provided in the marginal region in FIG. 6.

A deliberate thick point in the marginal region is formed in the thin point region in the marginal region in FIG. 7.

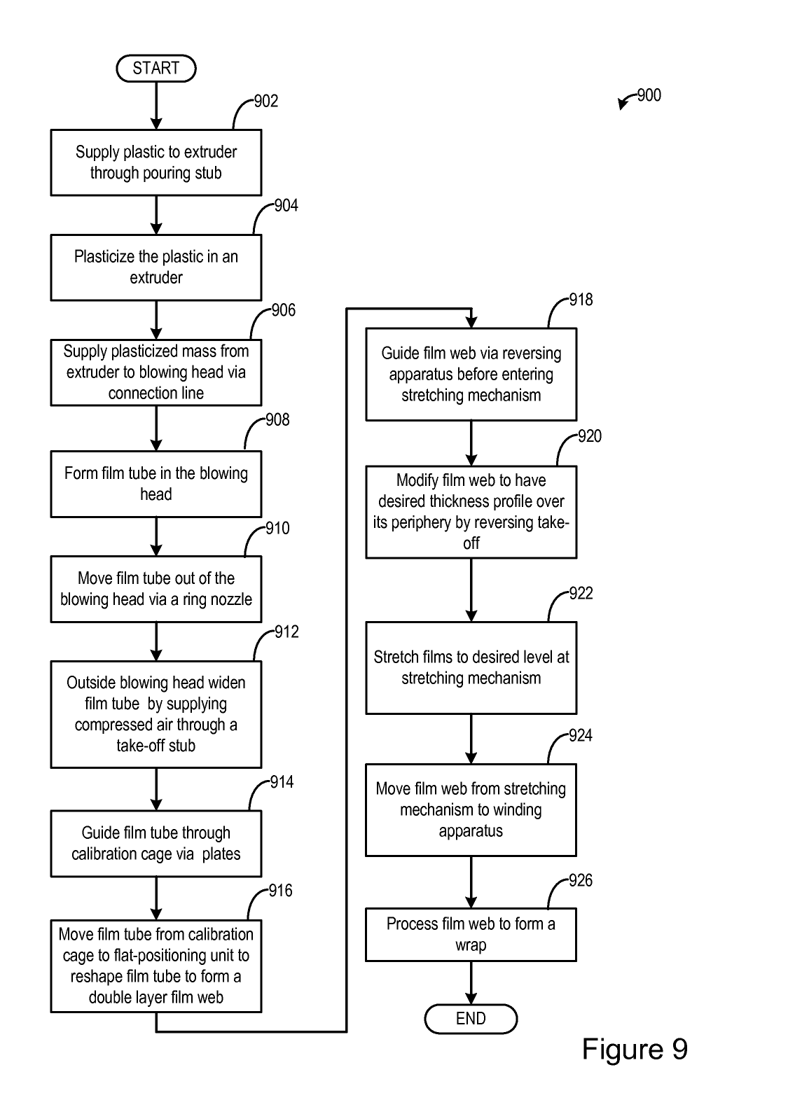

FIG. 9 illustrates an example method 900 that may be implemented for producing tubular films in a blown film extrusion unit. Instructions for carrying out method 900 may be executed by a control system coupled to the extrusion unit, such as control system 112 shown in FIG. 1. At 902, the routine includes supplying plastic (for example, in the form of plastic pellets) to an extruder through a pouring stub. At 904, the method includes plasticizing the plastic under high pressure and elevated temperature in an extruder to form a mass. At 906, the method includes supplying the plasticized mass from the extruder to a blowing head via a connection line. At the blowing head, at 908, the method includes forming a film tube from the plasticized mass. At 910, after formation of the film tube, the method includes moving the film tube out of the blowing head through a ring nozzle. At 912, the method includes, outside the blowing head, supplying compressed air through a take-off stub to widen the film tube after it exits the blowing head. The diameter of the film tube may be limited by a calibration cage. At 914, the method includes guiding the film tube through the calibration cage via plates. During this time, compressed air may be supplied onto the film tube. At 916, the method includes exiting the calibration cage and supplying the film tube to a flat-positioning unit where the film tube may be reshaped to form a double-layer web. At 918, after passing through the flat-positioning unit, the method includes guiding the film web into a stretching mechanism via a reversing apparatus. At 920, the method includes modifying the film web to a desired thickness profile over its periphery by reversing take-off such that the final film (after stretching) is of uniform thickness. At 922, after entering the stretching mechanism, the method includes stretching the film web to a desired level. At 924, the method includes transferring the film web from the stretching mechanism to a winding apparatus. At 926, the method includes processing the film web to form a wrap at the winding apparatus.

1. A method of regulating a thickness profile of an inline stretched film comprising:
positioning the film flat in a reversing take-off; and
after laying the film in a stretching unit, stretching the film monoaxially in a machine direction, wherein the stretching includes regulating the thickness profile of the film to have a deliberate thickening in a marginal region with respect to a mean film thickness over a total film width without marginal regions.

2. The method in accordance with claim 1, wherein a formed film thickness in the marginal region is between 15% and 100% thicker than the mean film thickness without the marginal regions.

3. The method in accordance with claim 1, wherein the marginal regions formed thicker are narrow with respect to the total film width.

4. The method in accordance with claim 5, wherein the marginal regions formed thicker have a width in a range of 5 mm-20 mm.

5. The method in accordance with claim 1, wherein two thick points disposed next to one another are formed in the marginal region of the film and a thin point is arranged between the two thick points.

6. The method in accordance with claim 1, wherein the stretched film a tubular film, and wherein the tubular film is regulated to a predefined desired thickness profile over its periphery.

7. The method in accordance with claim 6, further comprising, continuously reregulating the desired thickness profile of the film over the total film width based on the thickness profile of the film arising due to the reversing take-off and controlling individual segmented regulation zones of the film based on an association of one or more peripheral points of the flat-positioned tubular film with a plurality of regulation zones.

8. The method in accordance with claim 1, wherein the desired thickness profile is regulated based on a film thickness after the monoaxial stretching in the direction of the machine over the total film width, the film thickness measured by a measuring device.

9. The method in accordance with claim 8, wherein controlling the individual segmented regulation zones includes:
superpositioning a base profile on the desired thickness profile of the film and on a stretch profile of the film from the laying of the film by the reversing take-off, the controlling further based on influences of the stretching process on the thickness profile.

10. The method in accordance with claim 1, further comprising cutting off a narrow marginal region formed thicker in order to obtain a film having a uniform thickness profile over the total film width.

11. The method in accordance with claim 5, wherein the marginal regions formed thicker have a width in a range of 7 mm-10 mm.

12. A method, comprising:
reshaping a film tube into a flat film in a reversing take-off;
guiding the flat film from the reversing take-off into a stretching unit;
stretching the film monoaxially in a machine direction at the stretching unit until a thickness profile of the film includes a deliberate thickening in marginal regions of the film relative to a mean film thickness over a total width of the film without the marginal regions.

13. The method of claim 12, further comprising, wherein a width of the deliberately thickened marginal regions is narrower than the total width of the film.

14. The method of claim 12, wherein each of the thickened marginal regions include two thick points separated by a thin point.
